(19) United States
(12) Patent Application Publication
(10) Pub. No.: US 2024/0276285 A1
(43) Pub. Date: Aug. 15, 2024

(54) METHOD FOR ASSISTANCE INFORMATION DETERMINATION AND SIGNALLING DURING SMALL DATA TRANSFER

(71) Applicant: HUAWEI TECHNOLOGIES CO., LTD., Shenzhen (CN)

(72) Inventors: Jagdeep Singh AHLUWALIA, Reading (GB); Haibo XU, Beijing (CN); Mengchen ZHANG, Beijing (CN)

(21) Appl. No.: 18/640,802

(22) Filed: Apr. 19, 2024

Related U.S. Application Data
(63) Continuation of application No. PCT/CN2021/125427, filed on Oct. 21, 2021.

(51) Int. Cl. H04W 28/02; H04L 67/143; H04W 76/32; H04W 88/08

(52) U.S. Cl. CPC H04W 28/0221; H04L 67/143; H04W 76/32; H04W 88/085

(57) ABSTRACT

The present disclosure provides a communication node for operation as a part of a distributed base station entity in a communication system, the communication node being configured to, on establishment of a small data transmission communication session by a user equipment communicating with the distributed base station entity: receive from another part of the distributed base station entity a first message indicating assistance information for the session; and after traffic data has been transferred during the session, make a decision as to whether to terminate the session in dependence on the content of the first message.

### CROSS-REFERENCE TO RELATED APPLICATIONS

This application is a continuation of International Application No. PCT/CN2021/125427, filed on Oct. 21, 2021, the disclosure of which is hereby incorporated by reference in its entirety.

### FIELD OF THE APPLICATION

This application relates to assistance information determination and signalling during small data transfer. The application further relates to the configuration of communication nodes that form part of a distributed base station entity.

### BACKGROUND

Current systems that handle small data transmission (SDT) focus on supporting single shot transmission of data during the small data transmission. This single shot transmission of data refers to the scenario in which only one packet of data is transmitted and that this one packet contains all the data to be transmitted. This works well when the amount of data to be transmitted is small. However, when the amount of data is large it becomes difficult to send data as a single data packet as the required data cannot be accommodated by a single medium access control protocol data unit (MAC PDU).

In order to account for larger amounts of data to be sent it is necessary for a system to support multi-shot small data transfer. This is to account for at least two cases outlined below.

The first case being that there are multiple data packets (including both uplink (UL) message and downlink (DL) messages). In this case each packet is small but they are transmitted at different times. These packets necessarily transmitted by different transmissions. The second case is that in which one packet (DL or UL) is split into multiple transmissions due to its large size because the large size of the total transmission cannot be accommodated by a single shot MAC PDU transmission.

In both cases, during small data transfer there are a number of factors that must be taken into account as the multi-shot procedure design is more complex than single shot procedures. Since this is the case, a multi-shot procedure design requires additional information to be exchanged between the user equipment (UE) and the network (distributed base station entity) to efficiently support a multi-shot SDT procedure. In addition, assistance information used in SDT needs to be determined and transferred/signalled by the different network nodes (communication nodes) in the distributed base station entity architecture.

The information about subsequent DL and UL transmissions is usually known at the UE's application layer. From the network perspective, it would be beneficial to receive such information (single shot, multi-shot or the number of UL/DL packets or traffic pattern information) in the first UL message of SDT from the UE. Based on such assistance information (called SDT Assistance Information, SAI), the distributed base station entity can determine when to send an RRC Release message to terminate the SDT procedure.

Additionally, assistance information will be useful to help the anchor gNB to make the decision about whether or not to relocate the UE's context during SDT procedure and to promptly terminating the SDT procedure after all the UL data has been transferred by the UE rather than waiting for the SDT Timer to run close to expiry or to define a new inactivity timer to save UE power

As such new procedures are needed in order to effectively perform small data transmission when the base station entity is a distributed base station entity.

### SUMMARY

A communication node for operation as a part of a distributed base station entity in a communication system, the communication node being configured to, on establishment of a small data transmission communication session by a user equipment communicating with the distributed base station entity: receive from another part of the distributed base station entity a first message indicating assistance information for the session and/or traffic data for the session; and after traffic data has been transferred during the session, make a decision as to whether to terminate the session in dependence on the content of the first message. This allows effective small data transmission to be performed when the base station entity is a distributed base station entity.

There is also provided a communication node as above, wherein the communication node is capable of operating as a gNB-CU base station entity. This allows the communication node to be used as a central unit capable of communicating with a number of other communication nodes and user equipment.

There is also provided a communication node as above, wherein the first message is received by the communication node over an F1 interface. This provides a means for a communication node to communicate with other entities within the distributed base station.

There is also provided a communication node as above s, wherein the first message is received by the communication node from a gNB-DU base station entity. This expands the configuration of the distributed base station to include distributed units and allows further distribution of the base station entity.

There is also provided a communication node as above, wherein the assistance information indicates one or more of: an amount of data in the uplink and or downlink be communicated in the session and a content type of data to be communicated in the session. This allows detailed information about the content and or quantity of the data to be transmitted to passed to the other components of the distributed base station entity in order to assign resources for transmission.

There is also provided a communication node as above, wherein the assistance information indicates one or more of: an amount of data in the uplink and or downlink be communicated in a next session and a content type of data to be communicated in the next session including an indication that this assistance information is for the current or the next session. This allows detailed information about the content and or quantity of the data to be transmitted to passed to the other components of the distributed base station entity in order to assign resources for transmission for the next session.

There is also provided a communication node as above, wherein the amount of data is indicated as a number of packets. This allows the communication node to understand how much data is to be transmitted and allocate resources accordingly.

There is also provided a communication node as above, wherein the content type is indicated as an index to a predefined table of content types index of a lookup table with combination of uplink and or downlink packets to be exchanged.

There is also provided a communication node as above, wherein the communication node is configured to, during the small data transmission communication session, convey uplink data from the user equipment to a distributed base station entity and convey downlink data from the distributed base station entity to the user equipment.

There is also provided a communication node as above, wherein the communication node is configured to, on making a decision to terminate the session, transmit a user equipment context release command including RRC Release message to the another part of the distributed base station. This allows the communication node to manage the amount of resources allocated to user equipment.

There is also provided a communication node as above, wherein the communication node is configured to, after the transfer of the traffic data or due to encountering a failure condition, receive a RRC Message from a user equipment indicating a session termination request; in response to receiving the RRC message, decide whether to terminate the session; and transmit a context release command including an RRC Release message to the another part of the distributed base station. This allows the communication node to manage the amount of resources allocated to user equipment.

There is also provided a communication node as above, wherein the communication node is configured to, on making a decision to terminate the session, transmit a user equipment context release command including a release message to the another part of the distributed base station via an intermediate part of the distributed base station entity. This allows anchoring to be achieved by providing routing to obtain the correct UE context.

There is also provided a communication node as above, wherein the first message is received from the another part of the distributed base station entity via an intermediate part of the distributed base station entity. This allows anchoring to be achieved by providing routing to obtain the correct UE context.

In another aspect of the disclosure there is provided another communication node for operation as a part of a distributed base station entity in a communication system, the communication node being configured to, on establishment of a small data transmission communication session by a user equipment communicating with the distributed base station entity: receive from the user equipment a message indicating assistance information for the session; and in response to receiving that message transmit the assistance information for the session to another part of the distributed base station entity. This allows users to communicate with the distributed base station entity.

There is also provided a communication node as above, wherein the communication node is configured to forward uplink data for the session to a network via the another part of the distributed base station entity. This allows communication between communication nodes within a distributed system.

In another aspect of the disclosure there is provided another communication node for operation as a part of a distributed base station entity in a communication system, the communication node being configured to, on establishment of a small data transmission communication session by a user equipment communicating with the distributed base station entity: receive from another part of the distributed base station entity a message indicating assistance information for the session; and after traffic data has been transferred during the session, make a decision as to whether to terminate the session in response to receiving from the another part of the distributed base station entity a second message indicating that no further traffic data is to be transmitted in the session by the user equipment. This allows other communication nodes within the distributed base station entity to recognise when the main data transmission has ended.

There is also provided a communication node as above, wherein the communication node is capable of operating as a gNB-CU base station entity. This allows the communication node to be used as a central unit capable of communicating with a number of other communication nodes and user equipment.

There is also provided a communication node as above, wherein the first message is received by the communication node over an F1 interface. This provides a means for a communication node to communicate with other entities within the distributed base station.

There is also provided a communication node as above, wherein the message is received by the communication node from a gNB-DU base station entity. This expands the configuration of the distributed base station to include distributed units and allows further distribution of the base station entity.

There is also provided a communication node as above, wherein the assistance information indicates one or more of: an amount of data in the uplink and or downlink be communicated in the session and a content type of data to be communicated in the session. This allows detailed information about the content and or quantity of the data to be transmitted to passed to the other components of the distributed base station entity in order to assign resources for transmission.

There is also provided a communication node as above, wherein the amount of data is indicated as a number of packets. This allows the communication node to understand how much data is to be transmitted and allocate resources accordingly.

There is also provided a communication node as above, wherein the content type is indicated as an index of a lookup table with combination of uplink and or downlink packets to be exchanged. This allows the data to be easily ordered and stored within the distributed base station.

There is also provided a communication node as above, wherein the communication node is configured to, during the small data transmission communication session, convey uplink data from the user equipment to a network and convey downlink data from the network to the user equipment. This allows users to access the distributed base station entity.

There is also provided a communication node as above, wherein the communication node is configured to, on making a decision to terminate the session, transmit a user equipment context release command to the another part of the distributed base station. This allows the communication node to manage the amount of resources allocated to user equipment.

There is also provided a communication node as above, wherein the message is received from the another part of the distributed base station entity via an intermediate part of the distributed base station entity. This allows anchoring to be achieved by providing routing to obtain the correct UE context.

In another aspect of the disclosure there is provided another communication node for operation as a part of a distributed base station entity in a communication system, the communication node being configured to, on establishment of a small data transmission communication session by a user equipment communicating with the distributed base station entity: receive from another part of the distributed base station a control message along with the assistance information, for the session; transmit the control message to a communication system controller; and after transmitting the control message, receive a response to the control message from the communication system controller. This allows for control signals to be sent through the distributed base station entity.

There is also provided a communication node as above, wherein the response to the control message is an indication that there are multiple response messages to be received from the communication system controller and requesting that the communication node not terminate the session until further response messages have been received from the communication system controller.

There is also provided a communication node as above, the communication node being configured to, on receiving from the communication system controller a message indicating a change of radio resource status of the session to a connected state, transmit a message to the user equipment to signal it to enter a connected state. This allows the distributed base station entity to handle large and continuous amounts of data communicated from the user equipment.

There is also provided a communication node as above, the communication node being configured to, in response to receiving a response to the control message, transmit an information transfer message to another part of the distributed base station entity; and make a decision as to whether to terminate the session in response to receiving from the another part of the distributed base station entity an indication from another part of the distributed base station that the information transfer message was delivered to the user equipment. This ensures the session is terminated at the correct time.

There is also provided a communication node as above, the communication node being configured to, in response to receiving a response to the control message: generate a status request message to another part of the distributed base station entity; make a decision as to whether to terminate the session in response to receiving from the communication system controller a response to the control message and generate a termination message; transmit the status request message and the termination message as part of a single communication to another part of the distributed base station; and subsequent to transmitting the status request message and the termination message, receive from another part of the distributed base station entity, a delivery report. This allows the number of transmissions within the system to be reduced and thus power to be saved.

There is also provided a communication node as above, wherein the status message indicates one or more of information transfer message, an RRC delivery status request and radio bearer identification information. This allows the number of transmissions within the system to be reduced and thus power to be saved.

There is also provided a communication node as above, wherein the delivery report indicates one or more of RRC release information and downlink information transfer message. This allows the communication node to track the delivery of the messages it transmits.

There is also provided a communication node as above, wherein the communication node is configured to perform one or more of the steps of: receive the control message via an intermediate part of the distributed base station entity; transmit the status request message to the another part of the distributed base station via an intermediate part of the distributed base station entity; and receive the delivery report via an intermediate part of the distributed base station entity. This allows control messages to be transmitted throughout the distributed based station entity based on the user equipment context.

There is also provided a communication node as above, wherein the communication node is capable of operating as a gNB-CU base station entity. This allows the communication node to be used as a central unit capable of communicating with a number of other communication nodes and user equipment.

There is also provided a communication node as above, wherein the control message is received by the communication node over an F1 interface. This provides a means for a communication node to communicate with other entities within the distributed base station.

There is also provided a communication node as above, wherein the control message is received by the communication node from a gNB-DU base station entity. This expands the configuration of the distributed base station to include distributed units and allows further distribution of the base station entity.

There is also provided a communication node as above, wherein the assistance information indicates that there is data to be transmitted. This allows resources to continue to be allocated.

There is also provided a communication node as above, wherein the communication node is configured to, during the small data transmission communication session, convey uplink data from the user equipment to a network and convey downlink data from the network to the user equipment. This allows users to access the distributed base station entity.

There is also provided a communication node as above, wherein the communication node is configured to, on making a decision to terminate the session, transmit a user equipment context release command including RRC Release message to the another part of the distributed base station. This allows the communication node to manage the amount of resources allocated to user equipment.

There is also provided a communication node as above, wherein the control message is received from the another part of the distributed base station entity via an intermediate part of the distributed base station entity. This allows anchoring to be achieved by providing routing to obtain the correct UE context.

There is also provided a communication node as above, wherein on receiving the first message from the user equipment, the communication node is further configured to transmit a response message to the user equipment to enable the transmission of transmission data status reports; and after traffic data has been transferred during the session, the communication node is configured to send a release message to release resources used to send uplink data transmission data status reports for data transmission. In this way the allocated resources can be effectively managed.

There is also provided a communication node as above, wherein the response message is an acknowledgment, or a contention resolution message configured to allow the transmission of data status report messages.

There is also provided a communication node as above, wherein the response message is a downlink RRC message.

There is also provided a communication node as above, wherein prior to receiving the first message from the user equipment, the communication node is further configured to receive a non-small data transmission uplink message from the user equipment. This provides a secondary means of data transmission.

There is also provided a communication node as above, wherein the non-small data transmission uplink message is a trigger message that non-small data transmission data has been received and transmission data status reports transmission is enabled. This allows status report generation to be initiated in an alternate manner.

There is also provided a communication node as above, wherein the communication node is further configured to transmit a resume message to the user equipment to enable production of transmission data status reports and to release resources used for small data transmission. This allows for the number of messages transmitted to be reduced and thus power to be saved.

In another aspect of the disclosure there is provided a user equipment for operation as a part of a communication system, the user equipment being configured to communicate with the communication node as above, and further configured to, prior to establishment of a small data transmission communication session, enable production of transmission data status reports after re-establishing the packet data convergence protocol entities. This provides an independent user equipment means of re-enabling status report generation.

In another aspect of the disclosure there is provided a user equipment for operation as a part of a communication system, the user equipment being configured to communicate with the communication node according to any of the preceding claims, and further configured to, prior to establishment of a small data transmission communication session, transmit a non-small data transmission message to the communication node; and enable production of transmission data status reports. This provides an independent user equipment means of re-enabling status report generation.

### BRIEF DESCRIPTION OF THE FIGURES

The present application will now be described by way of example with reference to the accompanying drawings. In the drawings:

FIG. 1 illustrates an example about of a distributed base station entity, in particular the F1 and Xn interfaces between the distributed gNBs;

FIG. 2 illustrates an example about of a distributed base station entity architecture and the connections between communication nodes and the user plane;

FIG. 3 illustrates SDT Indication and SAI transfer to communication node over an F1 interface to terminate the SDT Procedure;

FIG. 4 illustrates SDT Indication and SAI transfer to the last serving communication node (gNB-CU) to anchor and then terminate the SDT procedure;

FIG. 5 illustrates assistance information derivation by communication nodes based on padding buffer status reports or padding bits or Release Assistance Information;

FIG. 6a illustrates assistance information derivation by communication nodes based on padding buffer status reports or padding bits and an indication of anchoring the gNB;

FIG. 6b illustrates assistance information included in the RRC message and an indication of anchoring the gNB;

FIG. 7 illustrates a base case for NAS signalling transfer within a distributed base station entity;

FIG. 8 illustrates an optimised case for NAS signalling transfer within a distributed base station entity;

FIG. 9 illustrates an optimised case for NAS signalling transfer within a distributed base station entity while anchoring;

FIG. 10 illustrates downlink NAS signalling transfer for a distributed base station entity including a state transition of the user equipment;

FIG. 11 illustrates a first embodiment procedure for re-enabling PDCP status reporting for small data transmission;

FIG. 12 illustrates a second embodiment procedure for re-enabling PDCP status reporting for small data transmission;

FIG. 13 illustrates a third embodiment procedure for re-enabling PDCP status reporting for small data transmission;

FIG. 14 illustrates a fourth embodiment procedure for re-enabling PDCP status reporting for small data transmission;

FIG. 15 illustrates a fifth embodiment procedure for re-enabling PDCP status reporting for small data transmission.

### DETAILED DESCRIPTION OF THE APPLICATION

Embodiments of the system to be described below introduces new procedures an F1 interface between the gNodeB distributed unit and gNodeB-Central Unit. The embodiments disclosed herein also describe new procedures between gNodeB-Central Unit, one of which acts as the last serving gNodeB-Central Unit, over an Xn-C(Xn) interface. The present disclosure therefore introduces new procedures on the F1 and Xn-C interfaces and enhances the existing F1 and Xn-C interface procedure.

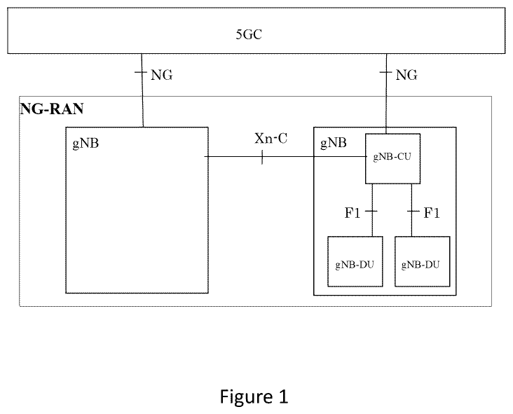

FIG. 1 shows an example of a distributed base station entity comprising gNodeB-Distributed Units (gNB-DU) that communicate over an F1 interface with gNodeB-Central Unit (gNB-CU). The gNB-CUs may be connected and communicate with AMF over a NG interface. FIG. 1 also depicts that the gNB-CUs may communicate with each other over an Xn interface in order to retrieve the context related to the relevant UE uplink data to be transmitted. The final gNB-CU that is accessed when the gNB-CUs communicate may be thought of as the last serving gNB-CU for the purpose of sending assistance information.

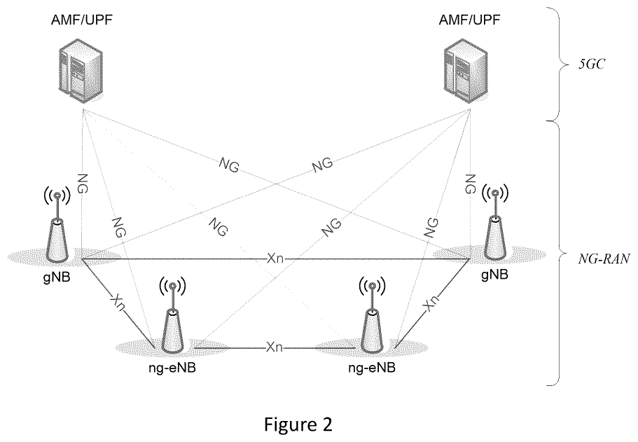

FIG. 2 shows a further example of a distributed base station entity comprising a number of communication nodes and the connections between them as well as the user plane connections to each of the nodes. Here the Xn interfaces between communication nodes can be seen as well as the levels of the architecture.

The assistance information to be reported from the UE to the network may be three types of information. SDT Assistance Information (SAI), Buffer Status Report (BSR) or Power Head Room Report (PHR). BSRs may be multiplexed together with user data in order to reduce the number of transmissions and therefore save power. The assistance information can be easily transmitted and used if the gNB of the base station entity is a single node. However, in cases described in the present disclosure, in which the gNB has a distributed architecture with CU and DU split then assistance information will be first received at MAC layer in the gNB-DU and needs to be transferred from gNB-DU to gNB-CU on the F1 interface. In a configuration in which there are multiple gNB-CUs, the assistance info may also have to be sent to further to the last serving gNB over a Xn-C interface. An example of the overall architecture of such a system (distributed based station entity) can also be seen in FIG. 2.

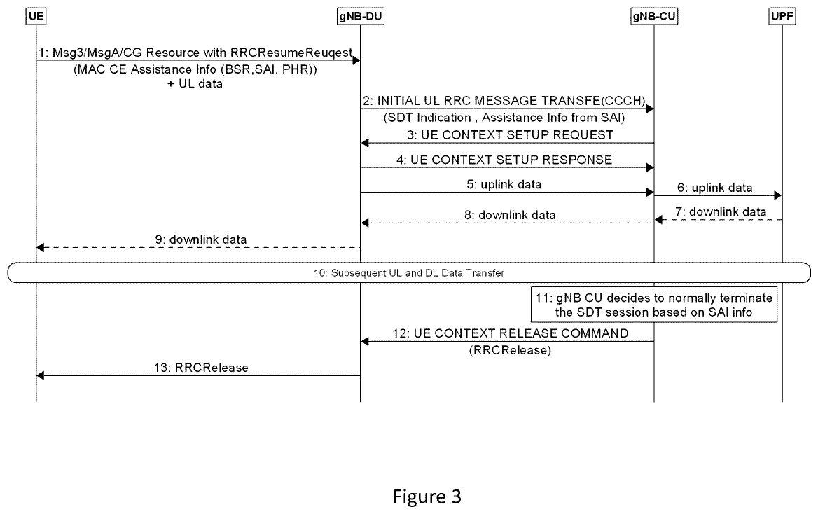

The apparatus and method of signalling of the assistance information across the distributed architecture will now be described with reference to FIGS. 3 to 10. In these figures components of a distributed base station entity will be described that allow small data transmission to occur and indicate when to release resources supplied to the user equipment for data transmission.

FIG. 3 describes uplink data transfer that uses SAI information transfer using the MAC level and transferring SAI assistance information from the user equipment to the gNB-CU in the uplink and/or downlink. The assistance information may include an amount of data in the uplink and or downlink be communicated in the session and a content type of data to be communicated in the session. The content type of data to be communicated in the session may be information regarding the contents of the data, other than the amount of data, that is to be transmitted as part of the session. The content type may be indicated as an index to a predefined table of content types index of a lookup table with combination of uplink and or downlink packets to be exchanged.

SAI information can be carried over the F1AP (F1 interface) as part of an initial UL RRC message transfer as new IE along with the SDT indication. This message can be used by the gNB-CU (communication node) to decide when to terminate the SDT session. When a small data transmission session is established, the user equipment is configured to transmit SDT assistance information in the form of SAI indicating assistance information and providing a RRC Resume Request. The assistance information sent from the UE is received at the gNB-DU as a layer 2 information this information is converted by the gNB-DU into layer 3 information that includes the SAI information and can be sent to the gNB-CU. There is no need to convert the layer 3 data back to layer 2 data before transmitting it to the user equipment. This transmission from the gNB-DU to gNB-CU is undertaken in the F1AP over a F1 interface. The gNB-CU receives this information as a first message and uses this information, that contains an indication regarding how many packets of data are to be sent, after traffic data has been transferred during the session to decide when to end the SDT session. Alternatively, in the case where no assistance information is transmitted by the UE, the gNB-CU may be configured to receive just the traffic data transferred to it. The traffic data may be user data. Once the gNB-CU has decided that the session should be terminated based on the assistance information. The gNB-CU then transmits a user equipment context release command, that may include an RRC Release message to the gNB-DU and subsequently the UE to terminate the SDT session. The user equipment context release command may be sent in response to the received assistance information or indication (either at MAC layer or RRC layer) from the user equipment that the UL data transfer has been completed. As such, the assistance information can be carried at both RRC or MAC layer in general and needs to be transferred across the distributed base station to the communication node that controls the SDT session. This is a distributed base unit entity wherein the gNB-CU in the system is the sole gNB-CU that contains the relevant context for the data transmission session.

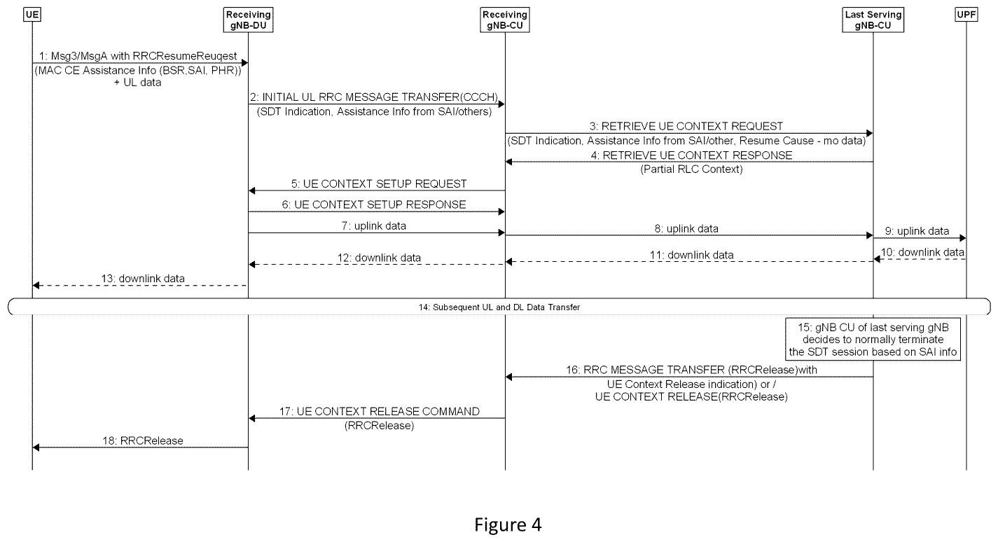

In FIG. 4, a similar distributed base station entity is disclosed that also describes an SDT session. The configuration of FIG. 4 differs from that of FIG. 3 in that the gNB-CU is also distributed. As such, SAI assistance information along with the SDT indication and resume cause may be carried to last serving gNB-CU over an XnAP (Xn interface) to retrieve UE context request information. Based on this the last serving gNB-CN may decide whether to relocate the UE context or not and when to terminate the SDT session. Therefore, where the receiving gNB-CU does not contain the correct context for the UE SDT transmission, the assistance information, SDT Indication, Resume Cause as mobile originated data is passed from the receiving gNB-CU to a last serving gNB-CU that contains the context. The receiving gNB-CU can be thought of as an intermediate part of the distributed base station entity. The assistance information may be carried to last serving gNB-CU in the XnAP to retrieve the UE Context Request. Based on this the last serving communication node may decide whether to relocate the assistance data or not and when to terminate the SDT session. The assistance information throughout FIGS. 3 and 4 may contain an amount of data information that may comprise the number of packets that are to be sent as part of the uplink transmission. The last serving gNB-CU communicates with the User Plane Function UPF (communication system controller) of the distributed base station entity.

The gNB-CU of the last serving gNB (communication node) then decides, after the transmission of packets of data during the SDT session, based on the SAI (assistance information), to terminate the session. In other words, the session is terminated in dependence on the content of the first message. Once the gNB-CU decides to terminate the session, an RRC message is transferred back to the UE via the gNB-DU. This message contains instructions regarding UE context release and RRC release message. The release message ensures that no further resources are allocated to the UE by the gNB-DU and the session is terminated.

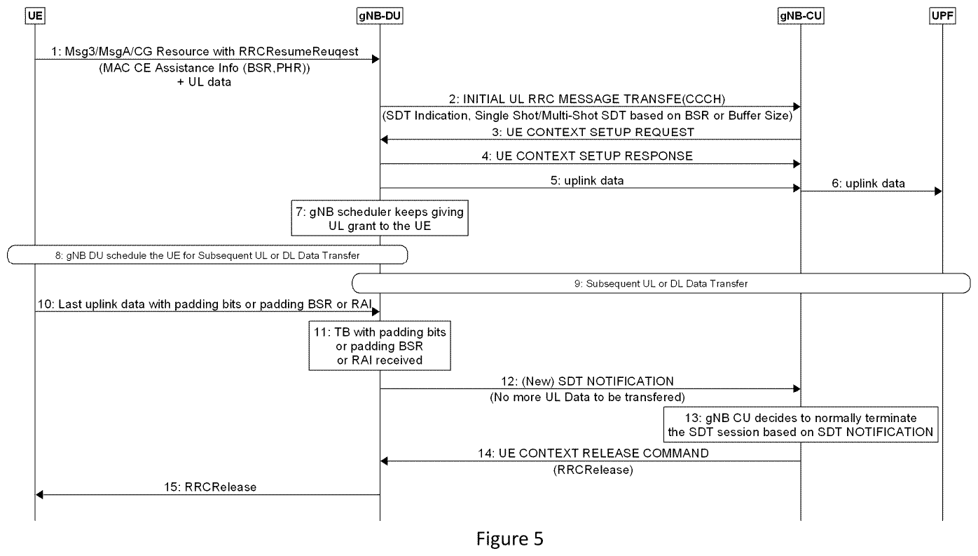

A further solution is disclosed in FIG. 5, in which instead of SAI information, a buffer status report (BSR) is transmitted from the UEs through the distributed system. The assistance information is derivation is based on buffer status reports and padding bits. In the case of new data arrival of SDT throughout a distributed base station entity during the ongoing SDT session, no new BSRs are triggered for new data arriving in the same LCG. In the example, procedural configuration of FIG. 5 the gNB-DU can continue allocating resources to the UE until the UE has no more data left to transmit. Once this occurs the UE signals this fact to the distributed base station entity by sending either padding buffer status reports or by sending padding bits. Alternatively this indication can also be sent by the UE in a RRC Message.

As can be seen in FIG. 5 a RRC Resume Request message is transmitted by the UE that may contain the buffer status reports. The assistance information aids in determining whether the transmission is single shot SDT or multi-shot SDT based on BSR. In order to achieve this, a new SDT Notification message is needed to be transmitted over the F1 interface to indicate the completion of SDT session to the gNB-CU. The gNB-DU receives this data converts it and transmits it to the gNB-CU (communication node). The gNB-DU determines whether the SDT session requires a single or multi-shot approach based on the BSR or the buffer size reported from the UE. For example, it may be unknown how many packets of data are to be transmitted, however it is known that there is “more” data to transmit during the session. UE context setup requests are then exchanged between the gNB-DU and the gNB-CU prior to uplink data being transmitted through the distributed base station entity to the UPF. As seen in step 7 of FIG. 5, the gNB-DU will continually allocate resources to the UE to allow for SDT to take place. This allocation of resources will continue to occur until, after the last data uplink, the UE begins to transmit a final transmission including padding bits or padding bits alone or RAI (Release Assistance Information) or BSR including padding bits.

Once the padding bits are received by the gNB-DU, the gNB-DU identifies these as the end of the data stream and transmits a message indicating this to the gNB-CU notifying it that no more UL data is to be transferred, see step 12 of FIG. 5. The gNB-CU then decides, based on this received notification message, to terminate the SDT session. On deciding to end the session the gNB-CU generates an RRC Release message that is transmitted from the distributed base station entity to the UE, where the session is terminated.

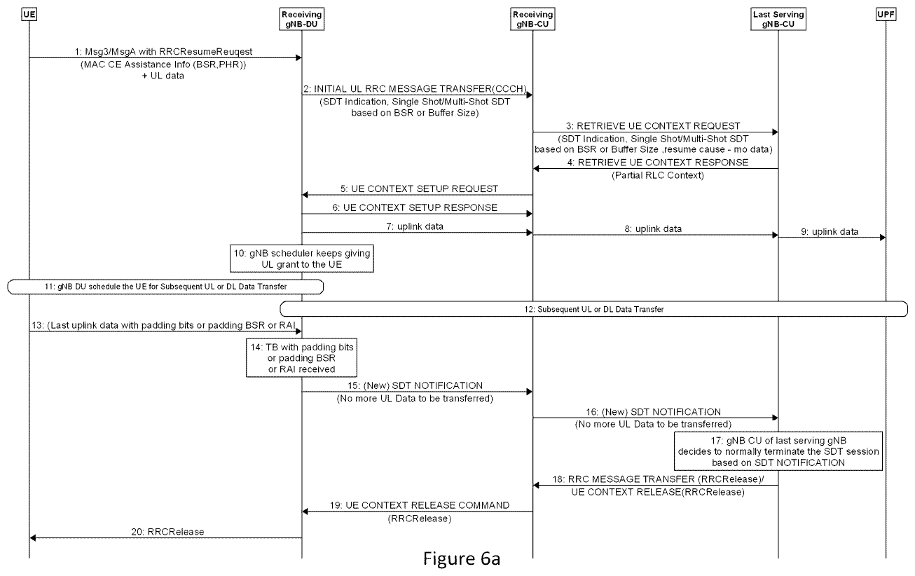

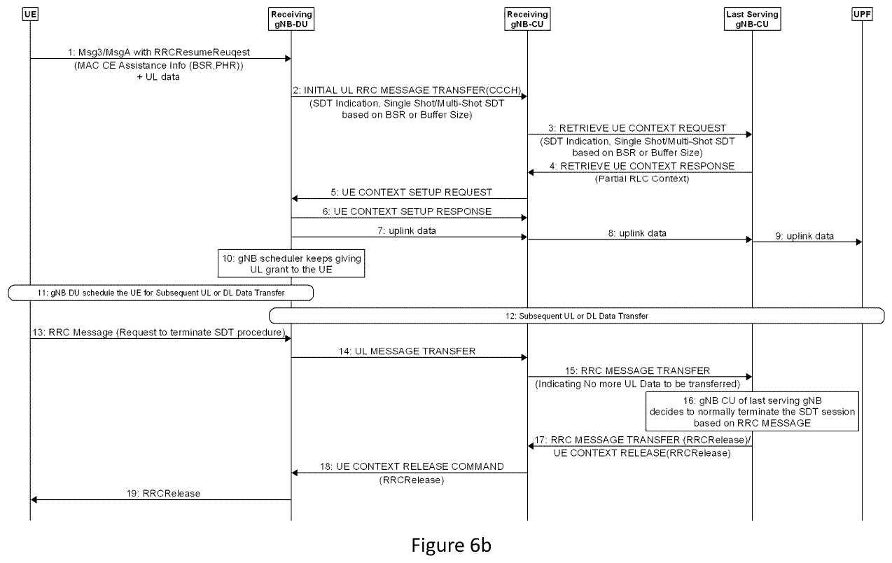

FIG. 6a represent a slightly modified distributed base station entity as described in relation to FIG. 5. In other words, the assistance information aids in determining whether the transmission is single shot SDT or multi-shot SDT based on BSR. In order to achieve this, a new SDT Notification message is needed to be transmitted over the F1 interface to indicate the completion of SDT session to the gNB-CU. However, a further new SDT notification message is needed on the Xn interface to indicate the completion of SDT session to last serving gNB-CU.

Said another way, the difference between FIGS. 5 and 6a being that once the BSR information, which may contain information as to whether the SDT transmission from the UE is single shot or multi-shot, is received by the receiving gNB-CU is it transferred to the last serving gNB-CU (communication node) that contains the correct context. In this configuration the communication node will construct and send the RRC Release message to the UE, via the other components of the distributed base unit entity. In other words, the SDT completion notification message is sent to last serving gNB for it to construct and send RRC Release message to the UE, UE context release message command may also be transmitted to the UE on termination of the session.

Another possible variant of FIG. 6a is shown in FIG. 6b where instead of using the padding bits to indicate that there is no more data to be sent in the uplink, the UE sends an RRC message to the network. This RRC message will be transferred all the way to the last serving gNB-CU (communication node) that contains the correct context, via the gNB-DU and receiving gNB-CU. In this configuration the communication node will construct and send the RRC Release message to the UE, via the other components of the distributed base unit entity.

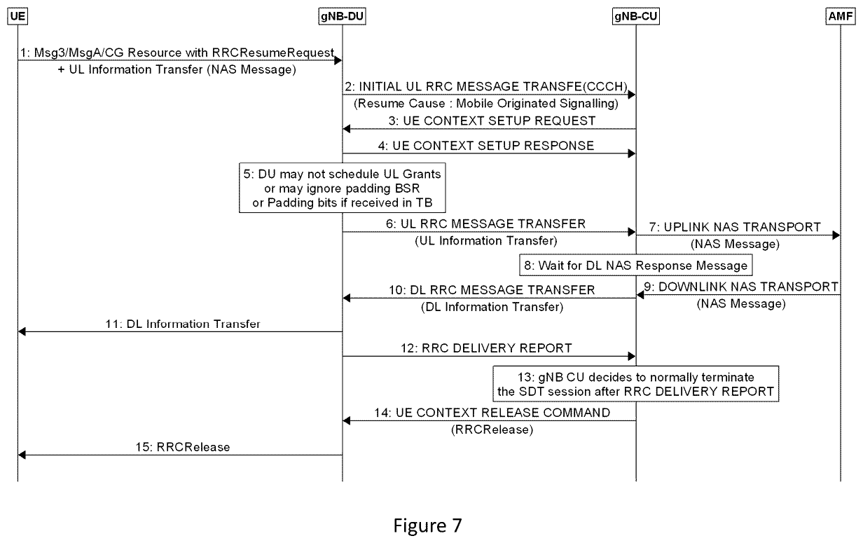

There is also disclosed herein, a communication node that may be part of a distributed base station entity as described above that is configured to receive a control message indicating assistance information, this is seen in FIG. 7. For a UE initiated NAS (control message) procedure, the gNB-DU can determine that it is a NAS signalling transfer based on the logical channel ID (LCID) over the Signal Radio Bearer 2 (SRB2) channel or Resume Cause value that may be included in the RRC Resume Request transmitted by the UE. The UE may also indicate the number of messages to be exchanged in UL/DL for the NAS Signalling and the BSR as assistance info.

In FIG. 7 a configuration is described wherein gNB-DU is configured to determine that the transmission from the UE is a NAS signalling transfer based on LCID of SRB2 and it may not schedule the UE with additional UE grant (resources), or if it does it will not send any indication of padding BSR or padding bits to gNB-CU. The gNB-CU of this configuration is also configured to wait for a DL response NAS message from the AMF.

The UE transmits a control message as part of the uplink information transfer as well a resource with RRC Resume Request. The resource may be a Msg3, MsgA, or CG resource. This control message is received by the gNB-DU and then forwarded onto the gNB-CU that serves as the communication node in the distributed base station of FIG. 7. In addition, to this message the UE context messages are exchanged between the gNB-DU an gNB-CU.

Importantly, step 5 of FIG. 7 describes that the gNB-DU may not schedule resources for uplink messages to be transmitted from the UE or may ignore padding bits if these are received in the transmission. This may be based on the NAS control message that is transmitted from the UE. This is important because resources are not utilised when not needed. The uplink RRC message comprising uplink information transfer received by the gNB-DU from the UE is then transmitted over the F1 interface where it is received by the gNB-CU. At this point the gNB-CU transmits the NAS control message to the Access and Mobility Management Function (AMF) of the distributed base station entity. This can be seen in steps 6 and 7 of FIG. 7. Once the gNB-CU has transmitted the control message to the AMF, also known herein as a communication system controller, it will wait to receive a response. As shown in FIG. 7, the communication node (gNB-CU) receives a downlink NAS control message from the AMF and in response to this transmits a downlink information transfer message to the gNB-DU, which in turn transmits the DL information transfer to the UEs. When the gNB-DU transmits this message to the UEs it also sends a delivery report message to the gNB-CU.

On receiving this delivery report, the gNB-CU then decides whether to terminate the SDT session and then when the session is to be terminated the communication node transmits a UE context release command message over the F1 interface to the gNB-DU, which in turn transmits the release message to the UE. These steps are shown in steps 12 to 15 of FIG. 7.

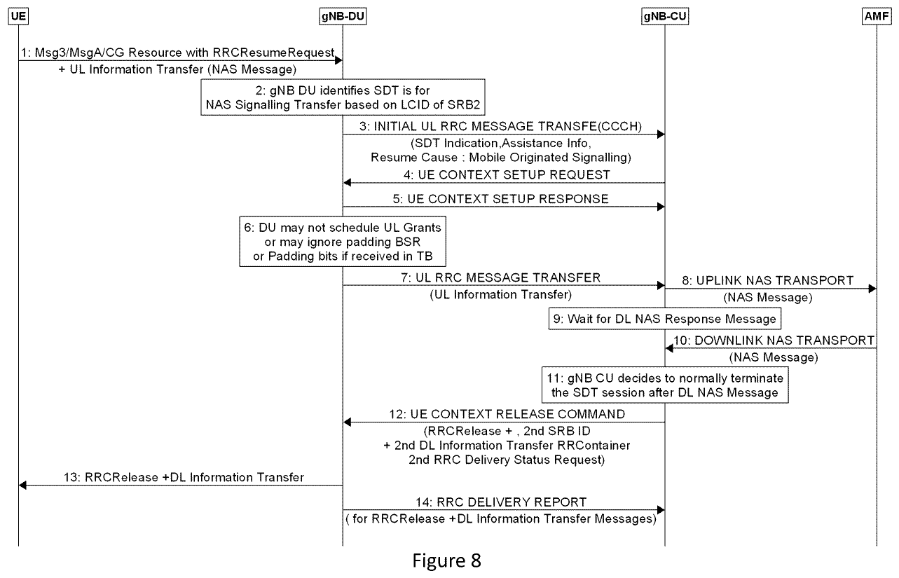

In an alternate but similar embodiment to that of FIG. 7, the gNB-DU of the distributed base station entity of FIG. 7 may be configured, upon receiving the NAS control message from the UE, to identify that the SDT is for NAS signalling transfer based on the LCID of SRB2, this is seen in step 2 of FIG. 8. Steps 1, 3 to 10 of FIG. 8 are the same as steps 1 to 9 of FIG. 7.

The procedure of FIG. 8 however, differs from that of FIG. 7 in the following way. Furthermore, the F1 interface message (UE context release command message) can carry both the RRC release message and the DL information transfer message as well as a new SRB ID, and a delivery status request (RRC delivery status request). The RRC delivery report is also extended to include both a release message (RRC release message) and a DL information transfer message status.

In response to receiving from the AMF (communication system controller) a response to the control message, the communication node is configured to generate a status request message to another part of the distributed base station entity. The communication node is further configured to make a decision as to whether to terminate the session in response to receiving, from the communication system controller, a response to the control message and generate a termination message. This termination message may be a UE context release command message as generated in FIG. 7, with the addition that it includes an additional information. For example, in FIG. 8 is can be seen that the communication node is configured in step 12, to transmit the status request message and the termination message as part of a single communication to another part of the distributed base station entity (the gNB-DU); and subsequent to transmitting the status request message and the termination message, receive from another part of the distributed base station entity, a delivery report (step 14). Between steps 12 and 14 of FIG. 8, the gNB-DU (the another part of the distributed base station entity in FIG. 8) is configured to transmit the release message and DL information transfer message to the UE. The configuration of FIG. 8 is an optimised version of the configuration shown in FIG. 7, wherein the messages in the downlink are combined, for example the release message in step 12. In this way the UE Context Release Command Message can carry both the Release (RRC Release) message and DL information transfer containers along with additional SRB ID and a delivery status request flag. The RRC delivery report is thus extended to include both RRC Release and DL Information Transfer Message status. The status message may indicate one or more of an information transfer message, an RRC delivery status request and/or radio bearer identification information. The delivery report may indicate one or more of RRC release information and downlink information transfer messages.

A possible variation of FIG. 8 can be that the AMF in the DL NAS transport message in step 10 may include an indication that there are multiple response messages to be sent and the gNB-CU should not decide to terminate the SDT procedure by sending a RRC Release message but instead should wait until further response messages have been received from the AMF (communication system controller). In other words, the response to the control message is an indication that there are multiple response messages to be received from the communication system controller and requesting that the gNB-CU not terminate the session until further response messages have been received from the communication system controller.

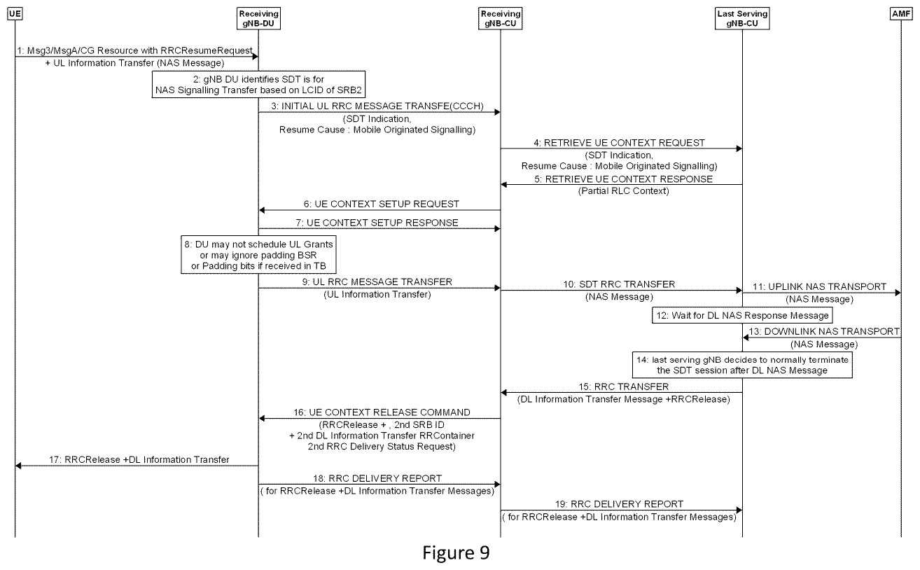

FIG. 9 depicts a further optimised NAS signalling transfer procedure while anchoring. A Xn SDT transfer message can carry both a release message (RRC release message) and a DL information transfer containers to transfer these together to the receiving gNB-CU. In the distributed base station of FIG. 9 there are again two gNB-CUs, a receiving gNB-CU and a last serving gNB-CU. This configuration differs from that of FIG. 8 in that the receiving gNB-CU transmits the retrieve UE context request and the NAS control message to the last serving gNB-CU (communication node). The receiving gNB-CU receives the UE context response from the last serving gNB-CU. This exchange of messages can be seen in steps 4 and 5 of FIG. 9. In FIG. 9 the gNB-DU performs the same function as in FIG. 8.

Since the receiving gNB-CU is not the last serving gNodeB, the last serving gNB-CU is configured to receive the NAS control messages, transmitted from the UE via the gNB-DU, from the receiving gNB-CU as shown in step 10. The last serving gNB-CU then decides whether to terminate the SDT session and transmits the delivery status request message a well as a termination message in the same way as described above in relation to FIG. 8. The difference being that these messages are transmitted to the another part (gNB-DU) of the distributed base station via an intermediate part (gNB-CU) of the distributed base station entity. The gNB-CU is further configured to receive the delivery report via an intermediate part of the distributed base station entity as seen in steps 18 and 19 of FIG. 9. As can be seen in step 15 upon receiving the downlink NAS control message from the AMF, the last serving gNB-CU, is configured to decide whether to terminate the SDT session and then transmit the downlink information transfer message as well as a release message to the receiving gNB-CU. The receiving gNB-CU then transmits a UE Context Release Command Message can carry both the RRC Release message and DL information transfer containers along with additional SRB ID and a delivery status request flag. The RRC delivery report is thus extended to include both RRC Release and DL Information Transfer Message status. The status message may indicate one or more of an information transfer message, an RRC delivery status request and/or radio bearer identification information. The delivery report may indicate one or more of RRC release information and downlink information transfer messages. Prior to receiving the delivery report, the gNB-DU (the another part of the distributed base station entity in FIG. 8) is configured to transmit the release message and DL information transfer message to the UE.

Using this configuration, the NAS signalling transfer throughout the distributed base station entity can be optimised to reduce the number of messages transmitted over the F1 and Xn interfaces and to identify when to terminate the SDT session and release the resources.

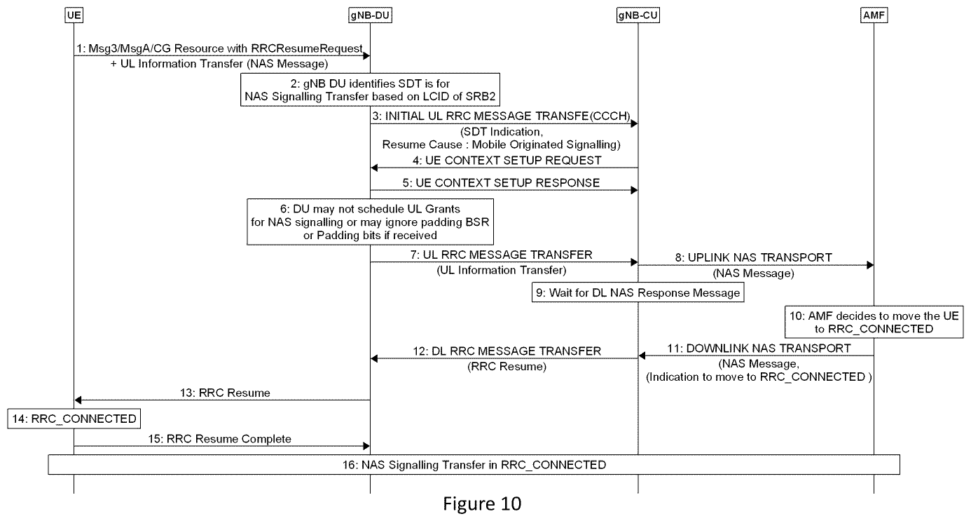

FIG. 10 depicts an example of downlink NAS signalling transfer with a state transition of the user equipment. The AMF of the configuration shown in FIG. 10 may instruct the communication nodes to move the UE to a connected state if the UE initiated NAS procedure cannot be continued in an RRC_INACTIVE state in response to receiving the UL NAS message. A connected state allows for continuous data transmission, for example during a video call, whereas in an inactive state the data transmission may be sporadic, for example using an instant messaging service where pauses occur between messages transmitted.

In the example of FIG. 10, the UE is configured to transmit, to a gNB-DU, a RRC resume request and uplink information transfer message (this is a NAS control message). The gNB-DU is configured to receive the transmission from the UE and identify that the small data transmission is for NAS signalling transfer based on the LCID of SRB2. In this configuration the NAS control signal may be thought of as assistance information. The gNB-DU may then be configured to transmit an initial uplink RRC message (CCCH) (Common Control Channel) as well as receive a UE context setup request from a gNB-CU. Once the context setup request has been received by the gNB-DU, a UE context setup response may be transmitted by the gNB-DU to the gNB-CU as shown in step 5. In step 6 the gNB-DU may not schedule at this point, resources to the UE for NAS signalling (data transmission) or may ignore padding BSRs or padding bits if received. The gNB-DU may then transmit in the uplink an information transfer message including a NAS message to the gNB-CU. The gNB-CU may then transmit the NAS message to in the uplink to the AMF in the user plane and wait for a DL response to the NAS message.

In response to receiving the NAS message, the AMF of FIG. 10 decides to move the UE to a connected state (RRC connected) in order perform continuous data transfer. An indication of this decision is transmitted in the downlink to the gNB-CU along with a response NAS message. These are sent as a single message. The indication is sent back through the distributed base station entity in the downlink as part of a resume message (RRC resume), seen in steps 12 and 13, to the UE. Upon receiving this indication, the UE is moved to the connected state and then NAS signalling transfer from the UE to the gNB-DU in the uplink direction is undertaken, seen in step 16 of FIG. 10.

Any communications between gNB-CUs in the present disclosure are performed on an Xn interface and any communications between a gNB-CU and a gNB-DU are performed over an F1 interface. The gNB-CUs and the gNB-DUs described herein may all be considered as communication nodes within the distributed base station entity.

There are some gaps on how the assistance information received from the UE is transferred from the gNB-DU to the gNB-CU in the CU-DU split architecture. Such information may also be carried to the last serving gNB-CU over a Xn interface. The depicted signalling procedures described herein describe the mechanism of signalling assistance information on the F1 and Xn interface.

Apart from the assistance information received at the beginning of SDT procedure, the UE may indicate that it does not have any UL data to transmit to the last serving gNB by sending padding BSR or padding bits in the TB or RAI MAC CE or a RRC Message. This information may be received from the UE by the gNB-DU and needs to be transferred from the gNB-DU to gNB-CU in the CU-DU split architecture described in this disclosure. Such information may also be carried to the last serving gNB-CU over an Xn interface between gNB-CU nodes to terminate the SDT procedure. The proposed procedures describe the mechanism of signalling such information on the F1 and Xn interfaces.

Additionally, the information on whether SDT procedure is used for NAS signalling transfer or uplink data may be implicitly derived in gNB-DU and conveyed to gNB-CU. The information can therefore be used to appropriately optimize the SDT procedure so that the downlink NAS message can be delivered together with RRC Release message so that the UE stops monitoring the control channels for further control transmissions at the earliest opportunity. This provides the advantage of reducing the power of the components.

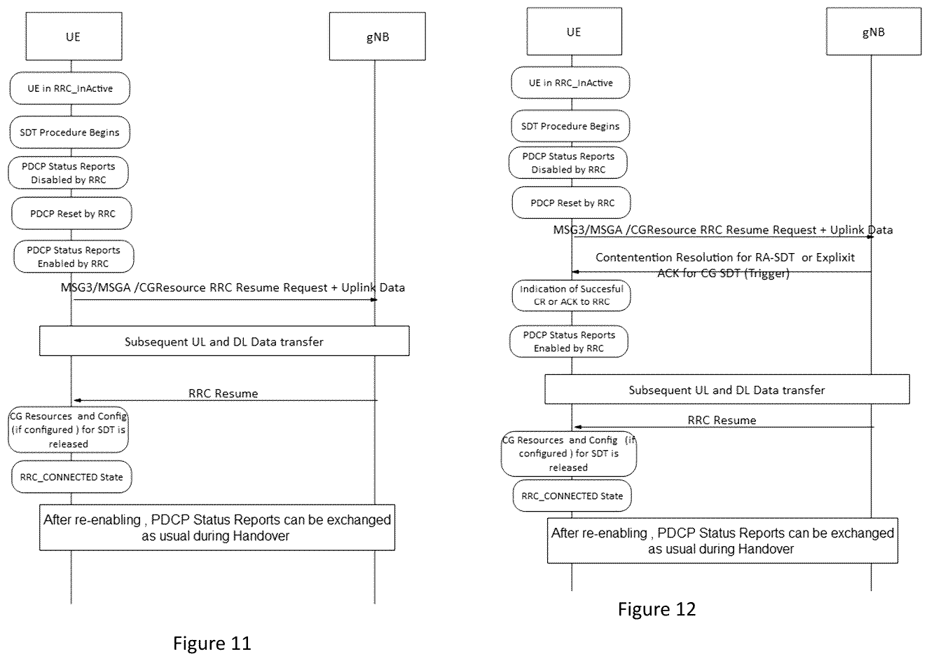

In a further embodiment of the present disclosure there is provided a communication node as previously described, capable of Packet Data Convergence Protocol (PDCP) status report disabling and enabling during small data transfer. This will be described in relation to FIGS. 11 to 15.

At initiation of SDT procedure, the PDCP status report is not triggered even if the RB Radio bearer is configured with the setting that a status report is required (statusReportRequired). PDCP status reports may be multiplexed together with user data in order to reduce the number of transmissions and therefore save power. Instead, at the initiation of a SDT procedure, the radio resource control (RRC) indicates to the PDCP to disable the PDCP status report. This may be done for example, by de-configuring the statusReportRequired command (i.e. the UE internally indicates this). PDCP status reporting may enabled using any method.

PDCP entities for only the non-SDT RBs may be re-established (i.e. not those for the SDT RBs) when the user equipment moves from an inactive state (RRC_INACTIVE) with SDT session ongoing to RRC CONNECTED.

The PDCP solution proposes when and how the PDCP status reporting is re-enabled within the UE for RA SDT and CG SDT when the UE moves to RRC_CONNECTED state and also for having lossless cell reselection procedure for both MO SDT and MT SDT.

FIG. 11 shows a first option for re-enabling PDCP status reporting for small data transfer. In FIG. 11, the UE is initially in an inactive state when the SDT procedure begins. In this state the PDCP status reports are disabled by RRC but are then reset by RRC. Once the reset of the PDCP has taken place the sending of PDCP status reports are enabled by RRC. A resume request is then transmitted from a UE to a gNB. Subsequently, traffic data is transferred during the session (uplink and downlink data transmissions take place that make up the SDT session) until a RRC resume message is transmitted from the gNB to the UE.

After traffic data has been transferred during the session, the communication node (integrated gNB in a single node architecture) is configured to send a release message to release resources used to send uplink data. At this point, the CG resources and configuration for small data transfer are released by the UE and the UE enters a connected state. After the re-enabling of PDCP status reports, these can then be exchanged in the usual manner during a handover.

In FIG. 11, there is provided a user equipment for operation as a part of a communication system (distributed base station entity). The user equipment being configured to communicate with the communication node (gNB) and further configured to, prior to establishment of a small data transmission communication session, enable production of transmission data status reports after re-establishing the PDCP entities.

FIG. 12 describes a second option for re-enabling PDCP status reporting for small data transfer. In FIG. 12 the same initial conditions and PDCP status are in place. However, the means by which the PDCP status reports are reenabled is different from that shown in FIG. 11. Importantly, instead of enabling PDCP status reports immediately, the UE is configured to transmit a resume request message to the gNB. In response to receiving this the gNB is configured to transmit a response message that includes contention resolution for RA-SDT or an explicit acknowledgement for CG SDT. In other words, the gNB is configured to transmit a trigger message.

The UE is configured to receive the response message and determine that a successful contention resolution or an acknowledgement of the resume request has been received. Once this is confirmed the UE is configured to re-enable PDCP status reporting and then commence traffic data transmission. Throughout this specification the traffic data is intended to represent the user data in other words the content of the messages transmitted during a SDT session.

After traffic data has been transferred during the session, the communication node is configured to send a release message to release resources used to send uplink data in the same manner as seen in FIG. 11. In the same way the UE is changed to a connected state. As such, it is possible to re-enable PDCP status reports after successful contention resolution for RA-SDT or acknowledgement for CG-SDT.

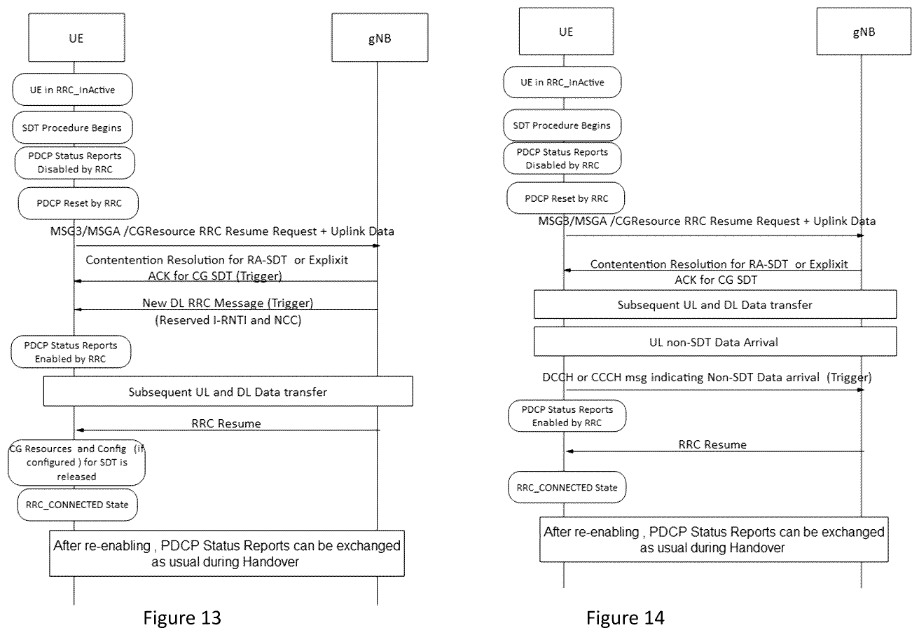

A further option for re-enabling PDCP status reporting is depicted in FIG. 13. In FIG. 13, the UE is initially in an inactive state when the SDT procedure begins. In this state the PDCP status reports are disabled by RRC but are then reset by RRC. Again, instead of enabling PDCP status reports immediately, the UE is configured to transmit a resume request message to the gNB-DU. This message may be a MSG3/MSGA/CG Resource RRC resume request and uplink data transmission. In response to receiving this transmission the gNB is configured to transmit a response message that includes contention resolution for RA-SDT or an explicit acknowledgement for CG SDT. In other words, the gNB is configured to transmit a trigger message.

Importantly, in the third option depicted by FIG. 13, the gNB is further configured to transmit an additional new trigger message that may be in the form of a downlink RRC message. This message may include an inactive—radio network temporary identifier (I-RNTI) and NCC.

The UE is configured to receive the new trigger message and re-enable PDCP status reporting and then commence traffic data transmission. After traffic data has been transferred during the session, the communication node is configured to send a release message to release resources used to send uplink data in the same manner as seen in FIG. 11. In the same way the UE is changed to a connected state. As such, it is possible to re-enable PDCP status reports after successful contention resolution for RA-SDT or acknowledgement for CG-SDT.

In FIG. 14 a further option for re-enabling PDCP status reporting in a SDT session is seen. In the embodiment of FIG. 14 the UE is initially in an inactive state when the SDT procedure begins. In this state the PDCP status reports are disabled by RRC but are then reset by RRC. A resume request is then transmitted from a UE to a gNB. Again, instead of enabling PDCP status reports immediately, the UE is configured to transmit a resume request message to the gNB. This message may be a MSG3/MSGA/CG Resource RRC resume request and uplink data transmission. In response to receiving this transmission the gNB is configured to transmit a response message that includes contention resolution for RA-SDT or an explicit acknowledgement for CG SDT. In other words, the gNB is configured to transmit a trigger message.

Subsequently, traffic data is transferred during the session (uplink and downlink data transmissions take place that make up the SDT session). The communication node (gNB) is further configured to receive a non-small data transmission uplink message from the user equipment. Once the non-SDT data becomes available, the UE is configured to transmit a trigger message to the communication node indicating that the arrival of the non-SDT data. This trigger message may be a DCCH or CCCH message. Once the trigger message has been transmitted by the UE to the gNB PDCP status reports are re-enabled by RRC and the UE is moved to a connected state on receipt of a resume message from the gNB. After the re-enabling of PDCP status reports, these can then be exchanged in the usual manner during a handover.

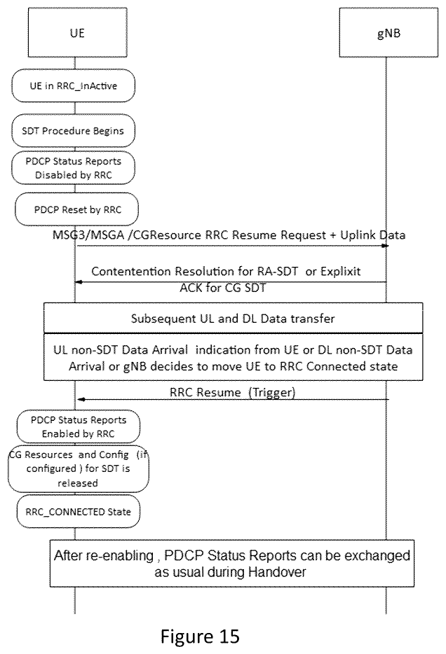

In a final embodiment of re-enabling PDCP status reports there is provided a modification of the configuration described above in relation to FIG. 14. This modified configuration is described below in relation to FIG. 15. FIG. 15 depicts re-enabling PDCP status reporting after receiving an RRC resume message either in response to a non SDT UL data arrival indication or a non SDT DL data arrival indication or if the network (distributed base station entity) decides to move the UE to a RRC connected state on its own.

In the embodiment of FIG. 15 the UE is initially in an inactive state when the SDT procedure begins. In this state the PDCP status reports are disabled by RRC but are then reset by RRC. A resume request is then transmitted from a UE to a gNB-. Again, instead of enabling PDCP status reports immediately, the UE is configured to transmit a resume request message to the gNB. This message may be a MSG3/MSGA/CG Resource RRC resume request and uplink data transmission. In response to receiving this transmission the gNB is configured to transmit a response message that includes contention resolution for RA-SDT or an explicit acknowledgement for CG SDT. In other words, the gNB is configured to transmit a trigger message.

Subsequently, traffic data is transferred during the session (uplink and downlink data transmissions take place that make up the SDT session). The communication node (gNB) is further configured to receive a non-small data transmission uplink message from the user equipment. The communication node may also transmit a non-small data transmission downlink message to the user equipment or may decide to move the UE to a connected state. When one or more of these actions take place, the gNB is configured to transmit a RRC resume trigger message that is received by the UE. Once this has happened the UE is configured to re-enable PDCP status reports (and the UE may be moved to a connected state if it has not been already) on receipt of a resume message from the gNB. In addition, the CG resources and configuration for small data transfer may be released. After the re-enabling of PDCP status reports, these can then be exchanged in the usual manner during a handover.

For the embodiments of FIGS. 11 to 15 relating to PDCP status report enabling for SDT, although the above examples are described with the user equipment communicating with a gNB-DU communication node, the communication node may be a gNB-CU if the system is not distributed.

In the above embodiments PDCP Status Reports may also be re-enabled in the PDCP layer by the RRC layer internally within the UE after the initiation of SDT procedure. This is applicable for both types of STD mechanism e.g., RACH based SDT (RA-SDT) or Configured Grant Based SDT (CG-Based SDT).

Some important features regarding the CG initial transmission acknowledgement are that explicit L1/L2 acknowledgement should be considered for the first SDT transmission including the RRC Resume request, or alternatively, L3 acknowledgement in the form of a new DL RRC message should be considered for CG SDT. Only after this acknowledgement is received should the subsequent transmission be performed on the CG or dynamic resources. Performing subsequent transmission without the acknowledgement of the first transmission should not be allowed. Furthermore, the handling of CG resources after the UE transitions to an RRC Connected State are as follows. When the UE transitions to the connected state, the CG Resources used for SDT should be released by the UE unless explicitly indicated by the distributed base station entity. The network (distributed base station entity) can indicate that the CG resources should be reused or reconfigured for the RRC connected state. This can be done in either a RRC resume message or in a RRC reconfiguration message later on in when the UE is in the connected state. If the network wants to reuse the CG SDT resources in RRC connected state, the RRC resume message described above may carry such an indication to do so when the UE moves from an inactive state (RRC_INACTIVE) to a connected state (RRC CONNECTED) while the SDT session is ongoing.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present application may consist of any such individual feature or combination of features. In view of the foregoing description it will be evident to a person skilled in the art that various modifications may be made within the scope of the application.

1. A communication node for operation as a part of a distributed base station entity in a communication system, the communication node being configured to, on establishment of a small data transmission communication session by a user equipment communicating with the distributed base station entity:
receive from another part of the distributed base station entity a first message indicating assistance information for the session and/or traffic data for the session; and
after traffic data has been transferred during the session, make a decision as to whether to terminate the session in dependence on the content of the first message.

2. The communication node according to claim 1, wherein the communication node is capable of operating as a gNB-CU base station entity.

3. The communication node according to claim 1, wherein the first message is received by the communication node over an F1 interface.

4. The communication node according to claim 1, wherein the first message is received by the communication node from a gNB-DU base station entity.

5. The communication node according to claim 1, wherein the assistance information indicates one or more of: an amount of data in the uplink and or downlink be communicated in the session and a content type of data to be communicated in the session.

6. The communication node according to claim 1, wherein the assistance information indicates one or more of: an amount of data in the uplink and or downlink be communicated in a next session and a content type of data to be communicated in the next session including an indication that this assistance information is for the current or the next session.

7. The communication node according to claim 1, wherein the amount of data is indicated as a number of packets.

8. The communication node according to claim 1, wherein the content type is indicated as an index of a lookup table with combination of uplink and or downlink packets to be exchanged.

9. A communication node for operation as a part of a distributed base station entity in a communication system, the communication node being configured to, on establishment of a small data transmission communication session by a user equipment communicating with the distributed base station entity:
receive from the user equipment a message indicating assistance information for the session; and
in response to receiving that message transmit the assistance information for the session to another part of the distributed base station entity.

10. A communication node as claimed in claim 9, wherein the communication node is configured to forward uplink data for the session to a network via the another part of the distributed base station entity.

11. A communication node for operation as a part of a distributed base station entity in a communication system, the communication node being configured to, on establishment of a small data transmission communication session by a user equipment communicating with the distributed base station entity:
receive from another part of the distributed base station entity a message indicating assistance information for the session; and
after traffic data has been transferred during the session, make a decision as to whether to terminate the session in response to receiving from the another part of the distributed base station a second message indicating that no further traffic data is to be transmitted in the session by the user equipment.

12. The communication node according to claim 11, wherein the communication node is capable of operating as a gNB-CU base station entity.

13. The communication node according to claim 11, wherein the first message is received by the communication node over an F1 interface.

14. The communication node according to claim 11, wherein the message is received by the communication node from a gNB-DU base station entity.

15. The communication node according to claim 11, wherein the assistance information indicates one or more of: an amount of data in the uplink and or downlink be communicated in the session and a content type of data to be communicated in the session.

16. The communication node as claimed in claim 15, wherein the amount of data is indicated as a number of packets.

17. The communication node as claimed in claim 15, wherein the content type is indicated as an index of a lookup table with combination of uplink and or downlink packets to be exchanged.

18. The communication node according to claim 11, wherein the communication node is configured to, during the small data transmission communication session, convey uplink data from the user equipment to a network and convey downlink data from the network to the user equipment.

19. The communication node according to claim 11, wherein the communication node is configured to, on making a decision to terminate the session, transmit a user equipment context release command to the another part of the distributed base station.

20. The communication node according to claim 11, wherein the message is received from the another part of the distributed base station entity via an intermediate part of the distributed base station entity.
